(19) United States
(12) Patent Application Publication
(10) Pub. No.: US 2020/0133275 A1
(43) Pub. Date: Apr. 30, 2020

(54) ELECTRONIC DEVICE AND METHOD OF OPERATING THE SAME

(71) Applicant: Samsung Electronics Co., Ltd., Suwon-si (KR)

(72) Inventors: Chiyul YOON, Suwon-si (KR); Yongsoo KWAK, Suwon-si (KR); Shingyu KIM, Suwon-si (KR); Eunvit CHUNG, Suwon-si (KR)

(21) Appl. No.: 16/662,682

(22) Filed: Oct. 24, 2019

(30) Foreign Application Priority Data
Oct. 25, 2018 (KR) 10-2018-0128440

(51) Int. Cl. G05D 1/00; H04R 1/02; H04R 1/04; H04R 1/40; H04R 3/00; G06T 7/70; G06F 3/16; G05D 1/02; G05B 13/02

(52) U.S. Cl. CPC G05D 1/0094; H04R 1/028; H04R 1/04; H04R 1/406; G05D 2201/0203; G06T 7/70; G06F 3/167; G05D 1/0246; G05B 13/0265; H04R 3/005

(57) ABSTRACT

The disclosure relates to an electronic device (e.g., a mobile robot). An electronic device is provided. The electronic device includes a speaker, a microphone, a substrate on which the speaker and the microphone are mounted, a spherical housing defining therein an inner space in which the speaker, the microphone, and the substrate are disposed, a support member configured to be in contact with and support an inner surface of the hosing on one side thereof, and a driver disposed in the inner space of the housing and including at least one power generation actuator and at least one wheel configured to rotate the housing by receiving power from the actuator, wherein the speaker is disposed adjacent to an another side of the support member opposite the one side of the support member, and outputs sound using oscillation of the surface of the housing. In addition, an electronic device according to various embodiments may be applied.

### CROSS-REFERENCE TO RELATED APPLICATION(S)

This application is based on and claims priority under 35 U.S.C. § 119(a) of a Korean patent application number 10-2018-0128440, filed on Oct. 25, 2018, in the Korean Intellectual Property Office, the disclosure of which is incorporated by reference herein in its entirety.

### BACKGROUND

### 1. Field

The disclosure relates to an electronic device (e.g., a mobile robot).

### 2. Description of Related Art

In a smart home environment, various types of electronic devices, which perform operations in response to commands from family members and emotionally interact with a user, are used.

As examples of the above-described electronic devices, artificial intelligence speakers, which operate in the form of being placed on a table or attached to a wall, are widely used in home environments. AI speakers are obtained by combining speakers, which have been used for listening to music or listening to the radio with voice recognition, cloud, and artificial intelligence techniques. Such AI speakers have evolved into platforms capable of managing or controlling various home appliances, beyond the level of tools for simply delivering sound. The AI speakers are designed to perform not only arithmetic operation functions, but also self-thinking and self-learning functions, thus providing evolved smart home environments.

A user may conveniently manage or control various home appliances (e.g., a robot cleaner, a washing machine, a refrigerator, an air purifier, and lighting) using an AI speaker, without directly touching the home appliances. An AI speaker may communicate with a user by voice using a speaker, a microphone, and a processor that has various algorithms stored therein in advance.

It may be necessary for the artificial intelligence speaker to be able to communicate with a user in various use environments. However, when the AI speaker is out of a physical range within which user recognition is enabled because a user is located far away from the space in which the AI speaker is installed or because a user is located in a space other than the space in which the AI speaker is installed, smooth communication may be interrupted.

FIG. 23 is a view illustrating the state in which multiple artificial intelligence speakers are disposed in a home according to the related art.

Referring to FIG. 23, it is possible to extend the physical range in which user recognition is enabled by providing, together with a main speaker H, sub-speakers S1, S2, and S3, which assist the main speaker H, in parallel in multiple spaces V1, V2, V3, and V4.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a mobile robot, which is capable of moving inside a home by having a wheel coupled to a main body having an artificial intelligence speaker embedded therein, whereby it is possible to provide smoother, three-dimensional, and active interaction between the artificial intelligence speaker and a user.

It may be quite expensive to provide the multiple speakers H, S1, S2, and S3, and to build a smart home system based thereon. In addition, according to the embodiment shown in FIG. 23, since the artificial intelligence speaker is fixedly installed at any one point, there is a disadvantage in that the artificial intelligence speaker can be used only in a limited space.

In addition, even if multiple speakers are installed, there is a limit in the range for performing interaction, and there is a disadvantage in that it is difficult to actively cope with a user's various movements or changes in position.

Additional aspects will be set forth in part in the description which follows and, in part, will be apparent from the description, or may be learned by practice of the presented embodiments.

In accordance with an aspect of the disclosure, an electronic device is provided. The electronic device includes a speaker, a microphone, a substrate on which the speaker and the microphone are mounted, a spherical housing defining therein an inner space in which the speaker, the microphone, and the substrate are disposed, a support member configured to be in contact with and support an inner surface of the housing on one side thereof, and a driver disposed in the inner space of the housing and including at least one power generation actuator and at least one wheel configured to rotate the housing by receiving power from the actuator, wherein the speaker is disposed adjacent to an another side of the support member opposite the one side of the support member, which is in contact with the inner surface of the housing, and configured to outputs sound using oscillation of the surface of the housing.

In accordance with another aspect of the disclosure, an electronic device is provided. The electronic device includes a speaker, an object detector, a microphone, a substrate on which the speaker, the object detector, and the microphone are mounted, a housing including a spherical outer housing defining therein an inner space in which the speaker, the object detector, the microphone, and the substrate are disposed, the outer housing being configured to come into contact with a ground, and an inner housing disposed inside the outer housing and spaced apart from the inner surface of the outer housing by a predetermined distance, a first support member configured to come into contact with and support the inner surface of the housing at one side thereof and connected to the speaker at an another side thereof, multiple second members configured to maintain the distance between the inner housing and the outer housing constant, a forward/reverse driver including at least one power generation actuator and at least one wheel configured to drive the outer housing by receiving power from the actuator, and a direction-converting driver configured to rotate the housing about a rotary shaft perpendicular to the ground, or configured to tilt the housing leftward and rightward, wherein the speaker outputs sound by causing the surface of the outer housing to oscillate.

According to various embodiments disclosed herein, it is possible to provide an electronic device (e.g., a mobile robot) used in a smart home environment. According to various embodiments disclosed herein, it is possible for an electronic device to have a structure advantageous to stimulate a user's emotional motive by having a simple and beautiful appearance (e.g., a spherical housing).

According to various embodiments disclosed herein, there is an advantage in that a movable electronic device enables smooth, three-dimensional, and active interaction with a user since the movable electronic device is provided with a low-power and compact vibration speaker.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram of an electronic device according to an embodiment of the disclosure;

FIG. 2 is a view illustrating an external appearance of an electronic device according to an embodiment of the disclosure;

FIG. 3 is a view illustrating various functional implementation elements included in an electronic device according to an embodiment of the disclosure;

FIG. 4 is a view illustrating an embodiment of operation of an electronic device according to an embodiment of the disclosure;

FIG. 5 is a view illustrating an embodiment of operation of an electronic device according to an embodiment of the disclosure;

FIG. 6 is a view illustrating an embodiment of operation of an electronic device according to an embodiment of the disclosure;

FIG. 7 is a conceptual view illustrating elements of an electronic device according to an embodiment of the disclosure;

FIG. 8A is a view illustrating elements of an electronic device illustrated in FIG. 7 in a disassembled state according to an embodiment of the disclosure;

FIG. 8B is a view illustrating elements of an electronic device illustrated in FIG. 7 in a disassembled state according to an embodiment of the disclosure;

FIG. 8C is a view illustrating elements of an electronic device illustrated in FIG. 7 in a disassembled state according to an embodiment of the disclosure;

FIG. 8D is a view illustrating an element of an electronic device illustrated in FIG. 7 in a disassembled state according to an embodiment of the disclosure;

FIG. 8E is a view illustrating an element of an electronic device illustrated in FIG. 7 in a disassembled state according to an embodiment of the disclosure;

FIG. 9 is a view illustrating an outer housing according to an embodiment of the disclosure;

FIG. 10 is a view illustrating an arrangement relationship between an outer housing and an inner housing according to an embodiment of the disclosure;

FIG. 11 is a perspective view illustrating a speaker and microphones mounted inside a housing disclosed herein in the state in which the speaker and the microphones are mounted on a substrate according to an embodiment of the disclosure;

FIG. 12 is a view conceptually illustrating an operation of outputting a voice through a vibration speaker according to an embodiment of the disclosure;

FIG. 13 is a view illustrating a front view of an embodiment illustrated in FIG. 11 according to an embodiment of the disclosure;

FIG. 14 is a view illustrating a side view of an embodiment illustrated in FIG. 11 according to an embodiment of the disclosure;

FIG. 15 is a view illustrating a support member different from the embodiment of FIG. 11 according to an embodiment of the disclosure;

FIG. 16 is a view schematically illustrating a forward/reverse driving of an electronic device according to an embodiment of the disclosure;

FIG. 17 is a view schematically illustrating a direction-converting driving of an electronic device according to an embodiment of the disclosure;

FIG. 18 is a view illustrating an operation algorithm of the electronic device according to an embodiment of the disclosure;

FIG. 19 is a view illustrating a method of directing a speaker towards a user according to an embodiment of the disclosure;

FIG. 20 is a view illustrating a method of directing a speaker towards a user according to an embodiment of the disclosure;

FIG. 21 is a view illustrating a method of directing a speaker towards a user according to an embodiment of the disclosure;

FIG. 22 is a view illustrating a method of directing a speaker towards a user according to an embodiment of the disclosure; and

FIG. 23 is a view illustrating the state in which multiple artificial intelligence speakers are disposed in a home according to the related art.

Throughout the drawings, like reference numerals will be understood to refer to like parts, components, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

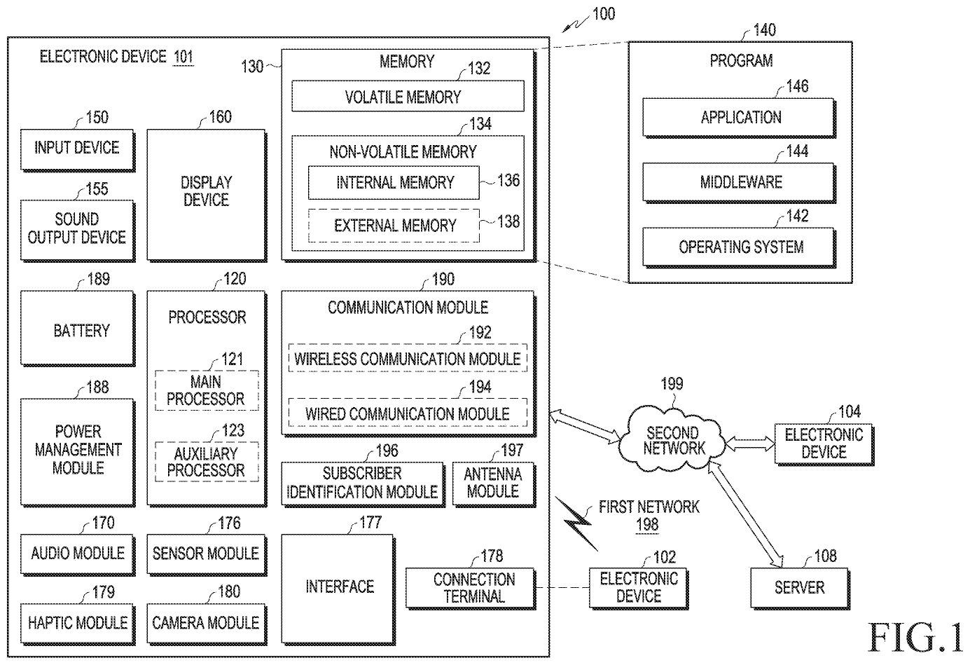

FIG. 1 is a block diagram illustrating an electronic device 101 in a network environment 100 according to various embodiments.

Referring to FIG. 1, the electronic device 101 in the network environment 100 may communicate with an electronic device 102 via a first network 198 (e.g., a short-range wireless communication network), or an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input device 150, a sound output device 155, a display device 160, an audio module 170, a sensor module 176, an interface 177, a haptic module 179, a camera module 180, a power management module 188, a battery 189, a communication module 190, a subscriber identification module (SIM) 196, or an antenna module 197. In some embodiments, at least one (e.g., the display device 160 or the camera module 180) of the components may be omitted from the electronic device 101, or one or more other components may be added in the electronic device 101. In some embodiments, some of the components may be implemented as single integrated circuitry. For example, the sensor module 176 (e.g., a fingerprint sensor, an iris sensor, or an illuminance sensor) may be implemented as embedded in the display device 160 (e.g., a display).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may load a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), and an auxiliary processor 123 (e.g., a graphics processing unit (GPU), an image signal processor (ISP), a sensor hub processor, or a communication processor (CP)) that is operable independently from, or in conjunction with, the main processor 121. Additionally or alternatively, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display device 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123.

The memory 130 may store various data used by at least one component (e.g., the processor 120 or the sensor module 176) of the electronic device 101. The various data may include, for example, software (e.g., the program 140) and input data or output data for a command related thererto. The memory 130 may include the volatile memory 132 or the non-volatile memory 134.

The program 140 may be stored in the memory 130 as software, and may include, for example, an operating system (OS) 142, middleware 144, or an application 146.

The input device 150 may receive a command or data to be used by other component (e.g., the processor 120) of the electronic device 101, from the outside (e.g., a user) of the electronic device 101. The input device 150 may include, for example, a microphone, a mouse, a keyboard, or a digital pen (e.g., a stylus pen).

The sound output device 155 may output sound signals to the outside of the electronic device 101. The sound output device 155 may include, for example, a speaker or a receiver. The speaker may be used for general purposes, such as playing multimedia or playing record, and the receiver may be used for an incoming calls. According to an embodiment, the receiver may be implemented as separate from, or as part of the speaker.

The display device 160 may visually provide information to the outside (e.g., a user) of the electronic device 101. The display device 160 may include, for example, a display, a hologram device, or a projector and control circuitry to control a corresponding one of the display, hologram device, and projector. According to an embodiment, the display device 160 may include touch circuitry adapted to detect a touch, or sensor circuitry (e.g., a pressure sensor) adapted to measure the intensity of force incurred by the touch.

The audio module 170 may convert a sound into an electrical signal and vice versa. According to an embodiment, the audio module 170 may obtain the sound via the input device 150, or output the sound via the sound output device 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a cellular network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., PCB). According to an embodiment, the antenna module 197 may include a plurality of antennas. In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 and 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, or client-server computing technology may be used, for example.

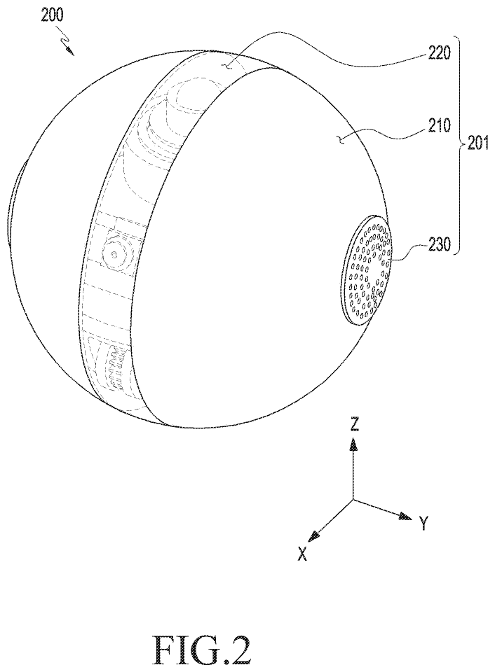

FIG. 2 is a view illustrating the appearance of an electronic device (e.g., the electronic devices in FIG. 1) according to an embodiment of the disclosure.

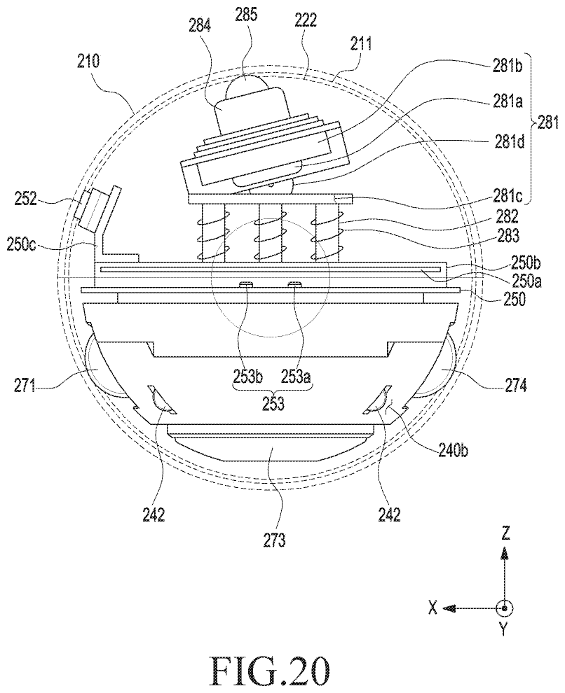

Referring to FIG. 2, artificial intelligence speakers (e.g., the speakers H, S1, S2, and S3 in FIG. 20) are often designed to have shapes and mechanisms specialized for implementing software functions. However, in an electronic device 200 disclosed herein, to which an artificial intelligence speaker and a mobile robot are coupled, technology development in terms of hardware for smoothly implementing software technology may be as important as technology development in terms of software. In addition, the electronic device may be designed to have a beautiful appearance in order to stimulate a user's emotional motive.

The electronic device 200 according to various embodiments disclosed herein may be designed to have a spherical housing 201. Referring to FIG. 2, a spherical housing 201 is illustrated, and respective elements indicated by reference numerals 210, 220, and 230 may be coupled to form the spherical housing 201. The wording “having a spherical housing 201” may mean that the spherical housing 201 has a surface that is “wholly or partially” or “substantially or completely” spherical.

The spherical housing 201 may be in contact with the floor (or ground) to be supported, and may be a portion that constitutes a substantially single body in the electronic device 200. According to various embodiments, the spherical housing 201 may be a drive element for moving the electronic device 200 in various directions in the state in which the electronic device 200 is placed on the floor.

The spherical housing 201 may also serve as a cover that protects the electronic device 200 from an external physical shock. The material of the spherical housing 201 may be set in various ways, but generally has a rigid material, and may pass over an obstacle (e.g., an irregular portion) formed on the floor.

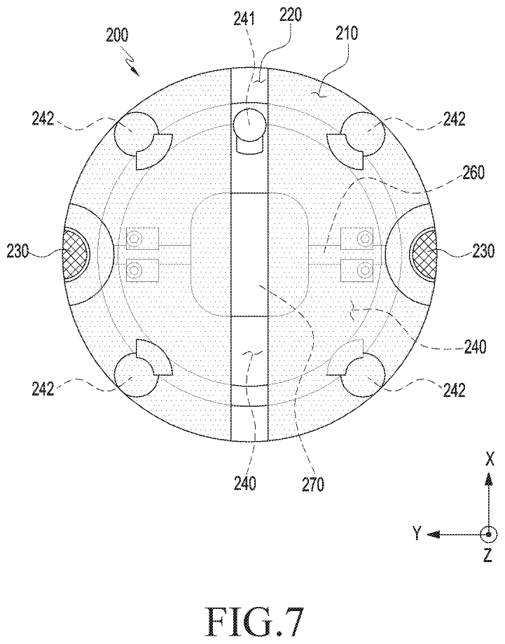

The spherical housing 201 may be formed to have various sizes. According to an embodiment, it may have a size similar to that of any of a variety of balls (e.g., a basketball ball, a soccer ball, or a volleyball ball). Alternatively, the spherical housing may be formed in a size more compact than the above-described “balls”, for example, a size similar to the size of an adult male palm. However, the disclosure is not necessarily limited thereto, and may be formed to have a larger volume or, conversely, to have a smaller volume. According to an embodiment, when the electronic device is formed as compact as the size of an adult male palm, it may be important to arrange each of various electronic components (e.g., a speaker and a microphone) for implementing functions (e.g., recording and speech recognition) inside a limited space) in place. The arrangements of respective components will be described later in detail with reference to the embodiments of FIG. 7 and subsequent drawings.

Referring to the embodiment illustrated in FIG. 2 regarding directional components, the directional components X, Y, and Z may be coordinate axes orthogonal to each other. According to this, the directional component X is perpendicular to the directional component Y, the directional component Y is perpendicular to the directional component Z, and the directional components X and Z may also be perpendicular to each other.

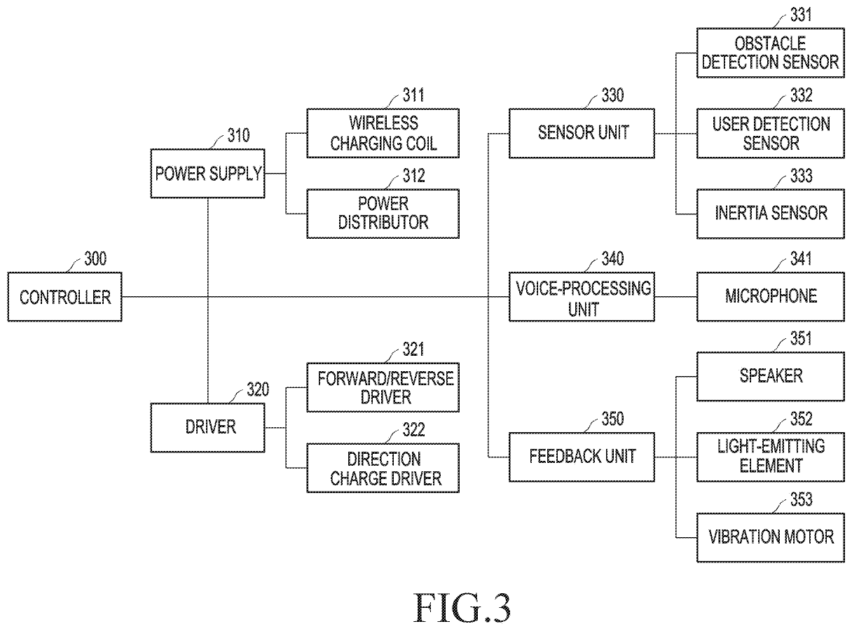

Hereinafter, various embodiments of operation of the electronic device 200 (e.g., electronic device 101 in FIG. 1) according to various embodiments will be described with reference to FIGS. 3 to 6.

FIG. 3 is a view illustrating various functional implementation elements included in an electronic device (e.g., the electronic device in FIG. 2) according to an embodiment of the disclosure.

Referring to FIG. 3, the electronic device (e.g., the electronic device 200 of FIG. 2) may further include a controller 300 (e.g., the processor 120 in FIG. 1). According to an embodiment, the controller 300 may operate a signal input through a user detection sensor (e.g., a camera), and may determine a traveling situation using the same. The electronic device (e.g., the electronic device 200 in FIG. 2) may be driven by activating a predetermined control algorithm.

According to various embodiments, the electronic device (e.g., the electronic device 200 in FIG. 2) may further include a power supply 310, a driver 320, a sensor unit 330, a voice-processing unit 340, and a feedback unit 350. Each of the power supply 310, the driver 320, the sensor unit 330, the voice-processing unit 340, and the feedback unit 350 may be electrically connected to the controller 300. For example, operations of the power supply 310, the driver 320, the sensor unit 330, the voice-processing unit 340, and the feedback unit 350, which will be described below, may be performed on the basis of the processing or arithmetic operation of various data or determination performed by the controller 300 or in response to commands from the controller 300.

According to various embodiments, the power supply 310 may include a wireless charging coil 311 and a power distributor 312. According to an embodiment, when it is determined that the electronic device (e.g., the electronic device 200 in FIG. 2) has a power lower than or equal to a predetermined value while traveling or standing by, the electronic device may be charged with power via the wireless charging coil 311 in the state of being docked in an external charging station (not shown). According to another embodiment, the electronic device (e.g., the electronic device 200 in FIG. 2) uses the power distributor 312 so as to adjust the amount of power applied to respective units (e.g., the units 320, 330, 340, and 350), thereby enabling the efficient use of power.

According to various embodiments of the disclosure, the driver 320 may further include a forward/reverse driver 321 and a direction-converting driver 322. The forward/reverse driver 321 provides a power generation/transmission mechanism for allowing the electronic device (e.g., the electronic device 200 in FIG. 2) to move forward or backward in a straight line, and the direction-converting driver 322 may provide a power generation/transmission mechanism for allowing the electronic device (e.g., the electronic device 200 in FIG. 2) to be out of a linear movement or to change direction in place. The specific mechanical configuration of the driver 320 may vary. That is, the configurations of the motor and the gear included in the forward/reverse driver 321 and the direction-converting driver 322 may vary depending on the embodiment. As a power generation/transmission mechanism applied to the driver 320 disclosed herein, any one of single wheel type, hamster car type, pendulum on rotating axis type, gimbal type, single ball type, mass movement type, orthogonally mounted flywheel type, flywheel on pendulum type, and parallelly mounted flywheel type mechanisms disclosed through “Mechanism and Machine Theory 68 (2013) 35-48”, or any one of combinations of at least two of these power generation/transmission mechanisms may be adopted.

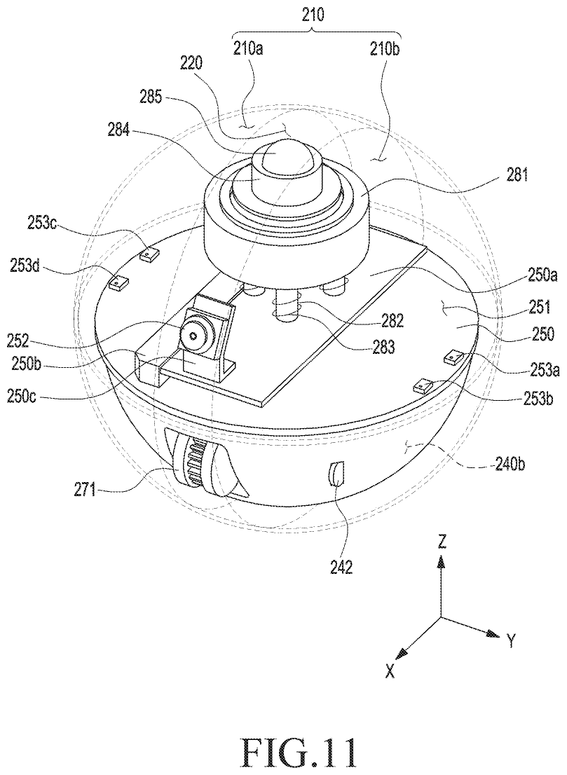

According to various embodiments, the sensor unit 330 (or an object detector) may include (or may be associated with) various sensors (including an obstacle detection sensor 331, a user detection sensor 332 (e.g., the camera 252), and an inertia sensor 333). The sensor unit 330 may be disposed in place in the electronic device (e.g., the electronic device 200 in FIG. 2) so as to easily acquire information from the outside of the electronic device (e.g., the electronic device 200 in FIG. 2). For example, as illustrated in FIG. 11 to be described later, the sensor unit 330 (e.g., a user detection sensor 332) may be disposed adjacent to the front surface of the spherical housing 201 (e.g., the front surface of the electronic device 200 in FIG. 2) to be oriented in the direction in which the electronic device (e.g., the electronic device 200 in FIG. 2) moves forward.

According to various embodiments, the voice-processing unit 340 may be configured to include (or be associated with) at least one microphone 341. When a user gives a command, the voice signal of a user may be received through the microphone 341, and the voice-processing unit 340 may recognize the same. The voice-processing unit 340 may perform the subsequent operations of the electronic device (e.g., the electronic device in FIG. 2) in response to a user's command by classifying and processing a user's voice signals by itself or in association with the controller 300. According to an embodiment, the electronic device (e.g., the electronic device 200 in FIG. 2) may include at least three microphones installed at different locations within the electronic device (e.g., the electronic device 200 of FIG. 2), and may receive voices through the microphones, thereby receiving the correct voice of a user, thereby recognizing the correct location of a user.

According to various embodiments, the feedback unit 350 may be configured to implement a function for the electronic device (e.g., the electronic device 200 of FIG. 2) to deliver a message to a user in the process of interacting with a user. According to various embodiments, the feedback unit 350 may include at least one of a speaker 351, a light-emitting device 352, and a vibration motor 353. Of course, the feedback unit 350 may further include various other elements in addition to those of the above-described embodiment as long as it can deliver a message to a user. For example, the electronic device (e.g., the electronic device 200 in FIG. 2) provides voice notification that a user's command is completed using the speaker 341, or the electronic device (e.g., the electronic device 200 in FIG. 2) notifies by voice a user of information such as the current status (e.g., the low power state) of the electronic device (e.g., the electronic device 200 in FIG. 2) using the speaker 351.

In addition, various embodiments may be applied.

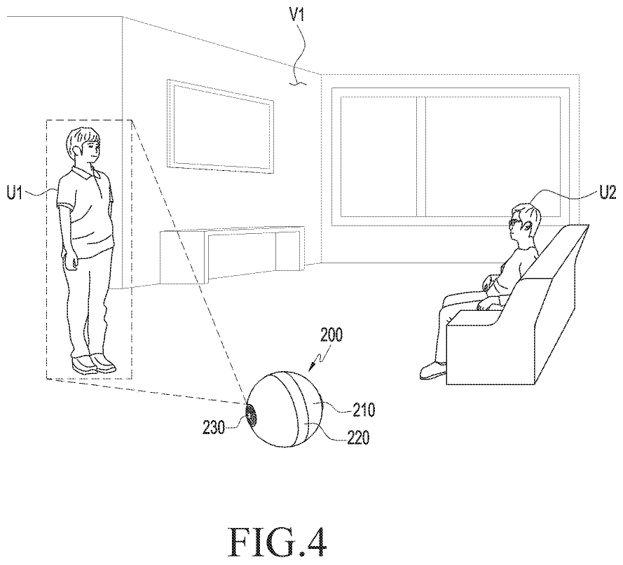

FIG. 4 is a view illustrating an embodiment of operation of an electronic device according to an embodiment of the disclosure.

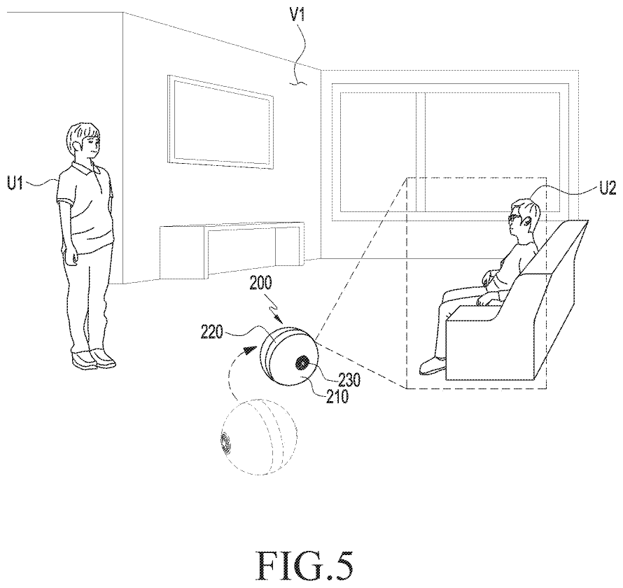

FIG. 5 is a view illustrating an embodiment of operation of an electronic device according to an embodiment of the disclosure.

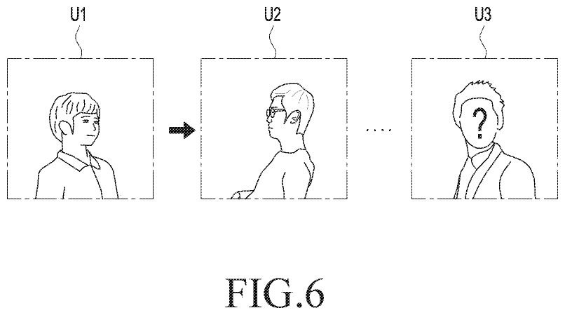

FIG. 6 is a view illustrating an embodiment of operation of an electronic device according to an embodiment of the disclosure.

The electronic device 200 may change the location thereof by rolling on the floor. According to an embodiment, the electronic device 200 disclosed herein may interact with a user at any one point. Alternatively, the electronic device 200 may interact with a user while freely moving to various points in various usage environments in which the electronic device 200 is placed.

Referring to FIGS. 4 and 5, they illustrate an embodiment in which the electronic device 200 interacts with different users in one space (e.g., V1), but the electronic device 200 may interact with a user while moving in different spaces.

According to various embodiments, the electronic device 200 may detect a user's call through the voice-processing unit (e.g., the voice-processing unit 340 in FIG. 3) in a stopped state (or a standby state). Here, the voice-processing unit (e.g., the voice-processing unit 340 in FIG. 3) may be continuously activated in order to detect a user's call. When a user calls the electronic device 200 in the state in which the voice-processing unit 340 is activated, the controller 300 may arithmetically operate the direction and location of the user and the distance between the user and the electronic device 200, and may activate the driver 320 so as to start moving. Until the electronic device 200 reaches the user, the electronic device 200 may determine, in real time, whether there is an obstacle, whether a user's location changes, the moving situation of the electronic device 200, or the like through the sensor unit (e.g., the sensor unit 330 in FIG. 3), and may control each element of the driver 320 through the controller (e.g., the controller 300 in FIG. 3). After the electronic device 200 reaches the front side of the calling user, the feedback unit 350 is activated to indicate that the electronic device 200 has reached the vicinity of the user or to indicate that the electronic device 200 is executing (or has executed) other commands, through a message transmission method using at least one of sound, light, and vibration.

Functions and operations that may be performed by the electronic device 200 in response to a user's command are not limited to specific ones, and may vary depending on the embodiment.

For example, the electronic device 200 may be used to leave a voice/video message to someone in the family. That is, the electronic device 200 may be used to transmit a message between family members. These commands may be useful when a family member is far from home.

As another example, the electronic device 200 may take care of a family member by itself or according to a user's command. When there is an elderly or infirm person among the family members, it is possible to make the electronic device 200 take care of the person and notify another family member of the situation based on the commands.

As another example, the electronic device 200 may be set to meet a family member at the front door by itself when the family member returns home.

As another example, when a user instructs the electronic device 200 to capture an image or video that is currently obtainable through the electronic device 200, the electronic device 200 may execute a command corresponding thereto. Then, the electronic device 200 may store the acquired data therein or may transmit the acquired data to another electronic device (e.g., the electronic device 102 in FIG. 1) (e.g., a user's portable terminal).

As another example, when a user wants to control another device (e.g., a robot cleaner, a washing machine, a refrigerator, an air purifier, or a lighting) in the home, the user may control a designated device using a communication module (e.g., the communication module 190 in FIG. 1) included in the electronic device 200.

In addition, the electronic device 200 may perform current weather notification, music playback, and various operations.

Referring to FIGS. 4 and 5 together, a command may be input from a user to the electronic device 200 in the state in which there are multiple users (e.g., U1 and U2) in a space (e.g., V1). In this case, according to an embodiment, the electronic device 200 may quickly scan a part (e.g., a face) of each user's body existing in a designated space (e.g., V1) using a sensor (a user detection sensor). In addition, the electronic device 200 may operate to search for a user for whom an operation is to be performed by comparing the actually input voice of a user with pre-stored (or pre-learned) voices and determining whether or not the actually input voice matches a pre-stored (or pre-learned) voice, and to interact with the searched user.

Referring to FIG. 6, the space in which the electronic device 200 searches for a user or performs an operation may not be limited to any specific space (e.g., V1). For example, a user who is to be scanned and searched by the electronic device 200 may not exist in the space (e.g., V1) in which the electronic device 200 is currently performing an operation, but may exist in another space. In addition, an object to be scanned and searched by the electronic device 200 may include not only a user for whom data has been previously stored (or previously learned) user, but also a user for whom data has not previously stored (or previously learned) (e.g., U3). The electronic device 200 may be set to respond to or interact with a new user's command.

FIG. 7 is a conceptual view illustrating elements of an electronic device (e.g., the electronic device in FIG. 1) according to an embodiment of the disclosure.

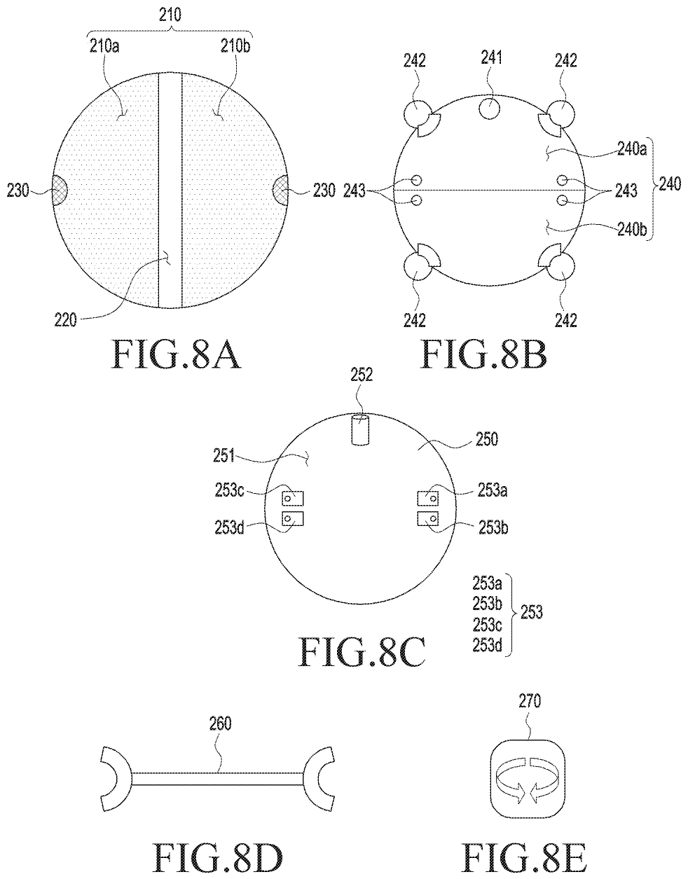

FIG. 8A is a view illustrating elements of an electronic device illustrated in FIG. 7 in a disassembled state according to an embodiment of the disclosure.

FIG. 8B is a view illustrating element of an electronic device illustrated in FIG. 7 in a disassembled state according to an embodiment of the disclosure.

FIG. 8C is a view illustrating element of an electronic device illustrated in FIG. 7 in a disassembled state according to an embodiment of the disclosure.

FIG. 8D is a view illustrating an element of an electronic device illustrated in FIG. 7 in a disassembled state according to an embodiment of the disclosure.

FIG. 8E is a view illustrating an element of an electronic device illustrated in FIG. 7 in a disassembled state according to an embodiment of the disclosure.

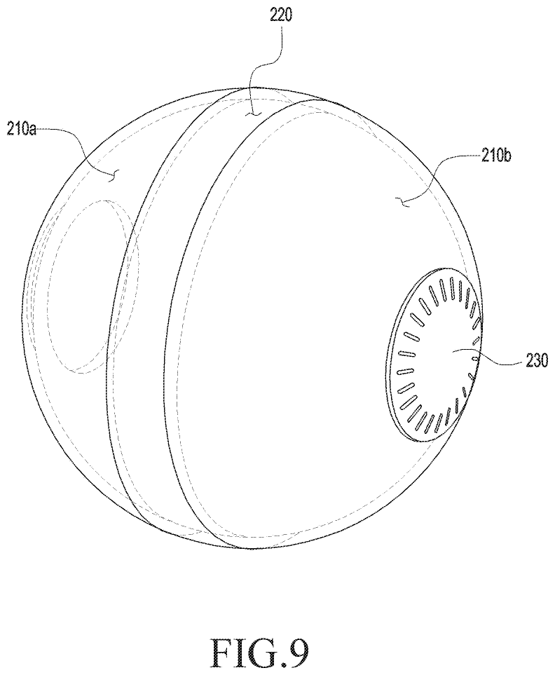

FIG. 9 is a view illustrating an outer housing according to an embodiment of the disclosure.

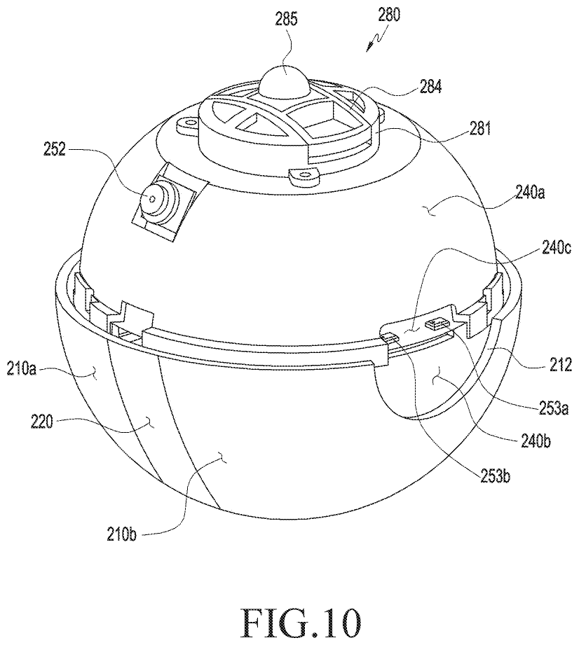

FIG. 10 is a view illustrating an arrangement relationship between an outer housing and an inner housing according to an embodiment of the disclosure.

Referring to FIGS. 7 and 8A, 8B, 8C, 8D, and 8E together, the electronic device 200 may include a spherical housing 201, and a microphone 253 and a substrate 250 on which the microphone 253 may be included inside the housing.

The spherical housing 201 may be formed by assembling at least two different portions (e.g., 210a, 210b, 220, and 230). The spherical housing 201 may generally have a spherical shape when viewed from the outside by assembling the at least two different portions (e.g., 210a, 210b, 220, and 230). According to an embodiment, the mating surfaces of the at least two different portions (e.g., 210a, 210b, 220, and 230) may be formed in various structures. Although not illustrated in the drawings, it is also possible to use screw coupling or to use separate fastening members. The at least two different portions (e.g., 210a, 210b, 220, and 230) may be firmly fastened such that the portions are not separated from each other when the electronic device 200 travels on an uneven floor surface or passes through an irregular or stepped portion.

According to various embodiments, the spherical housing 201 has an outer surface and an inner surface, and each of the outer surface and the inner surface may be formed to have a curved surface.

According to various embodiments, the spherical housing 201 may have a space surrounded by the inner surface and including various electronic components mounted therein. The spherical housing 201 may be relatively thin compared to the space, but may be formed of a scratch-resistant, rigid, and endurable material. The material of the spherical housing 201 may be made of, for example, polyethylene, polyethylene terephthalate, polycarbonate, glass, acrylic, various synthetic resins, or a combination of at least two thereof.

According to various embodiments, the spherical housing 201 may include a portion that is at least partially substantially transparent.

Referring to FIGS. 7 8A, 8B, 8C, 8D, 8E, and 9, the substantially transparent portion of the spherical housing 201 may be made of a transparent material such as glass or polycarbonate, including various coating layers thereon. In addition, the remaining portion other than the transparent portion may include a substantially opaque portion. The substantially opaque portion may be formed of, for example, coated or colored glass, ceramic, polymer, metal, or a combination of at least two of the above materials.

Referring to FIGS. 8A, 8B, 8C, 8D and 8E and 10 together, the spherical housing 201 may include an outer housing 210, which comes into contact with the ground, and an inner housing 240 located inside the outer housing 210 and spaced apart from the outer housing 210 by a predetermined distance. Since the outer housing 210 is larger than the inner housing 240 and is a portion that is in direct contact with the ground, the outer housing 210 may be a portion reinforced such that the surface thereof is highly scratch-resistant. The inner housing 240 is a component that protects components (e.g., a speaker, a microphone, and the like) located inside the outer housing 210, and may substantially enclose the components positioned inside the housing, except that some components (a camera 252 and/or a support member 285) are exposed outside the inner housing 240.

According to an embodiment, as illustrated in FIGS. 8A, 8B, 8C, 8D, and 8E, the outer housing 210 may include two substantially opaque portions 210a and 210b and a strip-shaped transparent portion 220 formed between the two substantially opaque portions 210a and 210b. Here, the strip-shaped transparent portion 220 may be a portion in which an object detector (e.g., a camera 252) (or the sensor unit 330 in FIG. 3) is formed. For example, the strip-shaped transparent portion 220 may be a portion formed such that a camera 252 (e.g., an optical camera) is capable of capturing an image of the outside of the electronic device 200. According to various embodiments, by including the strip-shaped transparent portion 220, the electronic device 200 may acquire external information through an object detector (e.g., the camera 252) located inside the spherical housing 201 while the electronic device 200 is traveling.

According to various embodiments, when the outer housing 210 includes two substantially opaque portions 210a and 210b, the two substantially opaque portions 210a and 210b may be symmetric to each other with respect to the strip-shaped substantially transparent portions 220.

The inner housing 240 may have any material and any transparency as long as the inner housing 240 substantially surrounds components located inside the outer housing 210. According to an embodiment, openings (first openings) are formed in the outer housing 210 at opposite sides thereof, respectively, and microphone hole cases 230 may be coupled to the openings (first openings), respectively. According to an embodiment, the outer housing 210 is capable of being moved forward or backward by rotating around the virtual axis connecting the microphone hole case 230 provided at the opposite sides. Accordingly, the portion of the outer housing 210 that is to come into contact with the ground, may correspond to the strip-shaped substantially transparent portion 220.

According to an embodiment, the strip-shaped substantially transparent portion 220 may move integrally with the substantially opaque portions 210a and 210b. However, the substantially transparent portion is not necessarily limited thereto, and may move separately from the substantially opaque portions 210a and 210b according to another embodiment. According to another embodiment, when the strip-shaped substantially transparent portion 220 rotates while the electronic device 200 is traveling, the substantially opaque portions 210a and 210b may not rotate.

The inner housing 240 may include a first hemisphere 240a and a second hemisphere 240b. One or more support members 242 and openings 243 (second openings) may be provided in the first hemisphere 240a and/or the second hemisphere 240b. In FIG. 8B, the first hemisphere 240a and the second hemisphere 240b are illustrated as being separated from each other in the vertical direction by the boundary therebetween, but are not necessarily limited thereto. According to another embodiment, the first hemisphere 240a and the second hemisphere 240b of the inner housing 240 may be separated in the horizontal direction by the boundary therebetween like the outer housing 210.

Referring back to FIG. 8B, the support members 242 may be configured to protrude from the surface of the inner housing 240. The support members 242 may be components that maintain a separation distance between the inner housing 240 and the outer housing 210 when the inner housing 240 is disposed inside the outer housing 210 and support the inner surface 211 of the outer housing 210. According to another embodiment, the support members 242 may be buffer external impacts applied to the electronic device 200. The positions and number of the support members 242 are not limited according to any specific embodiment. The positions of the openings 243 (second openings) may be formed to correspond to the positions of the microphone hole cases 230 (first openings) formed in the outer housing 210.

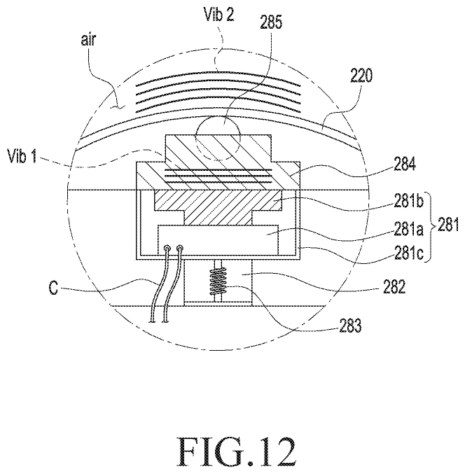

Referring to FIGS. 7 and 8B, the electronic device 200 may further include a support member 241 in addition to the support members 242. The support member 241 may be a component indicated by referential numeral 285 in FIG. 10. The support member 241 will be described later in detail with reference to FIGS. 11 and 12.

The openings 243 (second openings) may be configured such that the microphones 253 mounted on the substrate 250 receive sound signals from outside the electronic device 200. FIG. 8C illustrates four openings 243 (second openings) corresponding to the first to fourth microphones 253a to 253d, which will be described later, but the number of the openings 243 is not necessarily limited thereto. According to another embodiment, as illustrated in FIG. 10, two openings may be provided in the inner housing 240 at the opposite sides thereof, respectively. According to various embodiments, the second openings may be formed to have the shape of the openings 243 illustrated in FIG. 8B or the opening 240c illustrated in FIG. 10.

According to an embodiment, each of the microphone hole cases 230 may be provided with multiple through holes for transmitting sound to the microphones 253a to 253d. The microphone hole cases 230 may be coupled to seating surfaces 212 on the first openings at positions corresponding to the second openings 240c.

The substrate 250 may be a portion on which various electronic components are mounted to implement the functions of the electronic device 200. According to an embodiment, a camera 252 (or a camera module) may be mounted on the substrate 250, and in another embodiment, a speaker (not illustrated) may be mounted on the substrate 250. An embodiment in which a speaker (not illustrated) is mounted on the substrate 250 will be described in detail later with reference to FIG. 11.

Referring to FIGS. 7 and 8D and 8E, the electronic device 200 may further include a horizontal rotary shaft 260 and a direction change unit 270. Here, the horizontal rotary shaft 260 may be a portion interlocked with the forward/reverse driver (e.g., forward/reverse driver 321 of FIG. 3) described above with reference to FIG. 3, and the direction change unit 270 may be a portion interlocked with the direction-converting driver (e.g., the direction-converting driver 322 in FIG. 3) described above with reference to FIG. 3. In FIG. 7 and FIGS. 8A to 8D, the horizontal rotary shaft 260 passing through the opposite sides of the spherical housing 201 is illustrated as being installed inside the actual electronic device 200. However, the horizontal rotary shaft 260 is not necessarily limited thereto, and may have any shape as long as the horizontal rotary shaft 260 is configured such that the electronic device 200 can travel linearly by rotating around the horizontal rotary shaft, which is parallel to the ground.

According to an embodiment, at least a portion of the horizontal rotary shaft 260 may protrude to the outside of the inner housing 240 to be fastened to the inner surface of the outer housing 210.

The direction change unit 270 may have any shape, as long as the direction change unit 270 is configured to make the electronic device 200 change direction while traveling linearly. According to an embodiment, the direction change unit 270 may be a portion that is driven independently of the horizontal rotary shaft 260 that allows the electronic device 200 to linearly travel. In other words, when the electronic device 200 rotates in response to the rotation of the horizontal rotary shaft 260, the direction in which the electronic device 200 travels may be changed by the direction change unit 270.

For example, the direction change unit 270 may be a rotational inertia driver (e.g., a weight) disposed at the lower end of the inner housing 240. According to an embodiment, by moving a rotationally inertial driver clockwise or counterclockwise at the lower end of the inner housing 240, the electronic device 200 may perform leftward and rightward pendulum movement due to the rotational momentum (angular momentum).

However, it should be noted that the horizontal rotary shaft 260 and the direction change unit 270 are not limited to the above embodiment. As described above with reference to FIG. 3, various structures may be applied to the various embodiments disclosed herein depending on various power generation/transmission mechanisms.

FIG. 11 is a perspective view illustrating a speaker and microphones mounted inside a spherical housing (e.g., the outer housing) in the state in which the speaker and the microphones are mounted on a substrate according to an embodiment of the disclosure.

FIG. 12 is a view conceptually illustrating an operation of outputting a voice through a vibration speaker according to an embodiment of the disclosure.

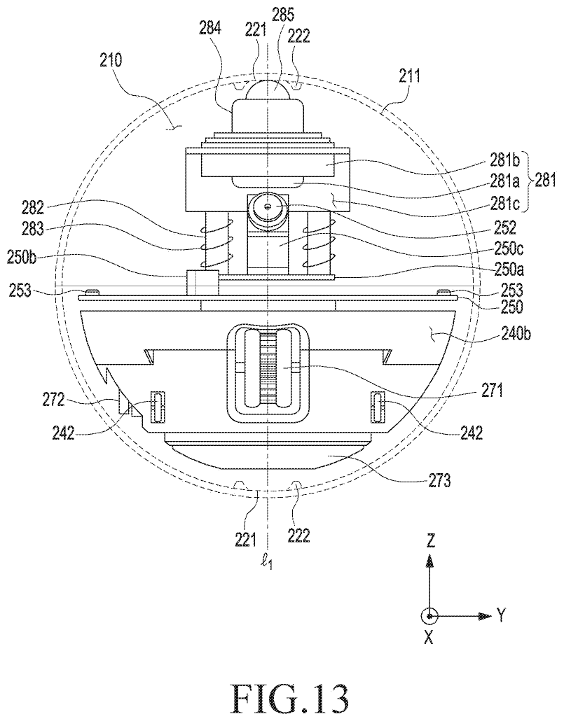

FIG. 13 is a view illustrating a front view of an embodiment illustrated in FIG. 11 according to an embodiment of the disclosure.

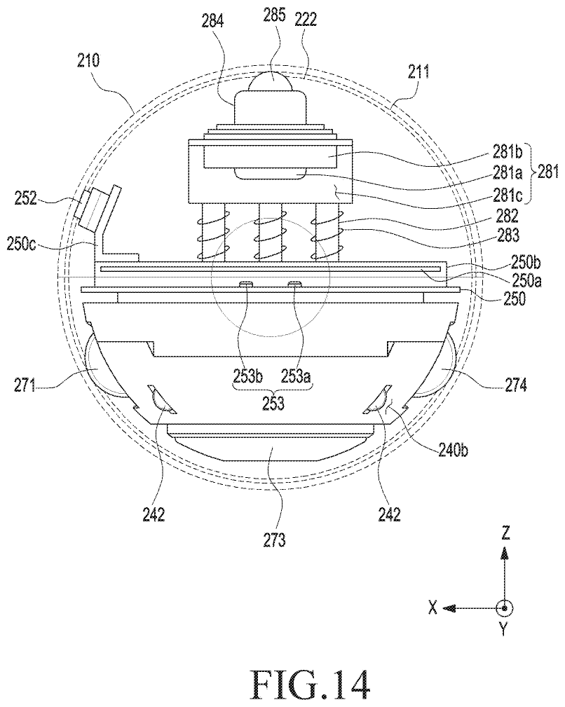

FIG. 14 is a view illustrating a side view of an embodiment illustrated in FIG. 11 according to an embodiment of the disclosure.

Referring to FIG. 11, an electronic device 200 may include: a speaker 281; microphones 253a, 253b, 253c, and 253d; a substrate 250 on which the speaker 281 and the microphones 253a, 253b, 253c, and 253d are mounted; and a spherical housing 201 (e.g., the spherical housing 201 in FIG. 2) forming therein an inner space in which the speaker 281, the microphones 253a, 253b, 253c, and 253d, and the substrate 250 are disposed. In addition, the electronic device 200 may include: a support member 285, which is in contact with and supports the inner surface 221 of the spherical housing 201 on one side thereof; and a driver (e.g., the driver 320 in FIG. 3) located in the spherical housing 201 and including at least one wheel 271 and at least one power-generating actuator 272. In addition, the speaker 281 according to an embodiment may be designed to come into contact with the other side of the support member 285, and may output sound using the oscillation of the surface of the spherical housing 201. For example, the speaker 281 may be a vibration speaker.

Referring to FIG. 11 may further include an outer housing 210. Referring to FIG. 11 a second hemisphere 240b of an inner housing (e.g., the inner housing 240 in FIG. 8) is shown, but a first hemisphere (e.g., the first hemisphere 240a in FIG. 8) of the inner housing (e.g., the inner housing 240 of FIG. 8) is not illustrated for convenience.

According to various embodiments, the speaker 281 may be substantially coupled to the support member 285 and the support member bracket 284, which are in contact with the inner surface 221 of the spherical housing 201 on one side thereof so as to form a single module 280.

According to various embodiments, the speaker 281 may be mounted on the substrate 250 (e.g., the second substrate 250b). According to an embodiment, the speaker 281 may be indirectly mounted on the substrate 250 via the support structure 282, rather than directly mounted on the substrate 250. With this arrangement, the speaker 281 may be disposed adjacent to the outer housing 210 at a position spaced apart from a upper surface 251 of the substrate 250 by a predetermined distance through the support structure 282. According to an embodiment, a structure (e.g., a molded structure) fabricated to simply place the speaker 281 thereon adjacent to the outer housing 210 may be used as the support structure 282. However, according to another embodiment, a portion of an electronic component (e.g., the battery) may be utilized as the support structure 282.

According to various embodiments, the electronic device 200 may further include an elastic body 283 disposed between the speaker 281 and the substrate 250. The elastic body 283 may serve to support the speaker 281 and the support member 285 so as to keep the same in close contact with the outer housing 210. According to an embodiment, multiple elastic bodies 283 may be provided to stably support the speaker 281 and the support member 285. In addition, the elastic body 283 may elastically support the lower portion of the speaker 281 in the state of being wound around the support structure 282.

According to various embodiments, the speaker 281 may be disposed, for example, adjacent to the upper end of the outer housing 210 when the electronic device 200 is viewed from the front side. Here, the upper end of the outer housing 210 may be a portion with which the end of the support member 285 is in contact in the embodiments illustrated in FIGS. 11 and 12, and may be a portion opposite the portion of the outer housing 210 that comes into contact with the ground.

According to an embodiment, since the speaker 281 is disposed adjacent to the upper end of the outer housing 210, the speaker 281 may uniformly output voice in 360° around the electronic device 200. In addition, the speaker 281 may evenly output voice in 360° around the electronic device 200 not only in the state in which the driving of the electronic device 200 is stopped, but also in the state in which the electronic device 200 is traveling. Since the speaker 281 is not directed to any specific direction, the speaker 281 may interact with the user while widely covering the space in which the electronic device 200 is disposed.

Referring to FIG. 12, the speaker 281 may further include a vibration motor 281a and a diaphragm 281b inside the speaker housing 281c. The vibration motor 281a is connected to a circuit C extending from the controller (e.g., the controller 300 in FIG. 3) disposed outside or on the substrate (e.g., the substrate 250), and thus the vibration (vib 1) operation of the diaphragm 281b according to a first frequency may be controlled. The diaphragm 281b may vibrate the support member 285 in the up/down direction in the state of being in contact with the lower portion of the support member bracket 284. Since the support member 285 vibrates in the up/down direction in the state of being in contact with a portion (e.g., the strip-shaped transparent portion 220) of the outer housing 210, vibration (vib 2) according to a second frequency may be output. Here, the first frequency and the second frequency may be the same, but may be different from each other depending on the materials of the support member and the outer housing. Here, the second frequency vibration transmitted to the air through the outer housing 210 corresponds to a voice frequency that is audible to a user.

Referring to FIGS. 11, 13, and 14, the substrate 250 according to various embodiments may include a first substrate 250 and a second substrate 250a. The first substrate 250 may be, for example, a main substrate, on which electronic components (e.g., the processor 120) required for driving the electronic device 200 are mounted. The second substrate 250a may be formed separately from the first substrate 250, and may be a portion, which forms a step with the first substrate 250. According to an embodiment, the second substrate 250a may be connected to the first substrate 250 via various components (e.g., the support structure 282). Electronic components (e.g., the camera 252 or the speaker 281) specialized for implementing a function may be mounted on the second substrate 250a. However, it should be noted that the substrate 250 disclosed herein is not limited to the embodiments illustrated herein, and other forms according to various embodiments are also applicable.

According to various embodiments, a microphone 253 for interacting with a user may be mounted on the substrate 250. A plurality of microphones 253 may be provided. For example, at least three microphones 253 may be provided at different positions on the substrate 250.

According to various embodiments, openings are formed in the outer housing 210 on opposite sides, respectively, and the microphones 253 may be mounted on the substrate 250 at the positions corresponding to the openings.

According to various embodiments, at least one microphone 253 may be provided on the substrate 250 at a position corresponding to one of the openings in the outer housing 210, and at least one microphone 253 may be provided at a position corresponding to the remaining one of the openings in the outer housing 210. In this case, at least three microphones 253 may be provided on the substrate 250 so as to three-dimensionally receive the voice of a user located outside the electronic device 200.

According to an embodiment, as in the embodiments illustrated in FIGS. 11, 13, and 14, the microphones 253 may include four microphones 253a, 253b, 253c, and 253d. Here, two microphones 253a and 253b may be mounted on one side of the substrate 250, and two other microphones 253c and 253d may be mounted on the other side of the substrate 250. In addition to receiving voices in both directions of the electronic device 200, the voices received through the microphones may be processed according to a predetermined voice processing algorithm based on the distance between two adjacent microphones 253a and 253b.

According to various embodiments, the electronic device 200 may further include a camera 252 for capturing an image of the outside of the electronic device 200. According to an embodiment, the camera 252 may be disposed adjacent to one side (e.g., the front portion) of the outer housing 210 using a third substrate 250c (e.g., a flexible printed circuit board (FPCB)).

According to various embodiments, when at least a part of the outer housing 210 is formed as a transparent portion, the camera 252 may be disposed at a position corresponding to the transparent portion. According to an embodiment, the outer housing 210 may include two substantially opaque portions 210a and 210b and a strip-shaped transparent portion 220 formed between the two substantially opaque portions 210a and 210b, and the camera 252 may be disposed at a position corresponding to the strip-shaped transparent portion 220.

Referring to FIGS. 13 and 14, the strip-shaped substantially transparent portion 220 of the outer housing 210 may extend in the shape of a strip in the central portion of the outer surface of the outer housing 210. A support member 285 and a camera 252 may be disposed adjacent to the outer housing 210 along the strip-shaped transparent portion 220. The lower portions of the support member 285 and the camera 252 may be supported via the speaker 281 and the third substrate 250c, respectively, and may disposed adjacent to the outer housing 210 in the state of being spaced apart from the substrate 250 by a predetermined distance.

Referring to FIG. 13, the support member 285 may be in contact with the inner surface 221 of the strip-shaped transparent portion 220 in the inner surface of the outer housing 210. An anti-separation portion 222 may be formed on the inner surface 221 of the strip-shaped transparent portion 220 so as to guide the support member 285 such that the support member 285 is not separated from the inner surface 221 of the strip-shaped transparent portion 220 while the electronic device 220 is traveling. According to an embodiment, the anti-separation portion 222 may be a portion protruding from the inner surface 221 of the strip-shaped transparent portion 220 by a predetermined height.

The electronic device 200 according to various embodiments disclosed herein may include a driver disposed inside the outer housing 210. As described above, the driver may include a forward/reverse driver and a direction-converting driver.

According to various embodiments disclosed herein, as in the embodiments illustrated in FIGS. 11, 13, and 14, various electronic components disposed in the electronic device 200 may be mainly disposed in the form of being mounted on a substrate 250 enclosed by a second hemisphere 240b of the inner housing 240 or disposed in (or above) the second hemisphere 240b of the inner housing 240. Since multiple large and heavy components are disposed in the second hemisphere 240b, the center of gravity of the electronic device 200 may be lowered so as to enable stable operation of the electronic device 200. Various electronic components disposed in the second hemisphere 240b may include, for example, drivers (or a forward/reverse driver and a direction-converting driver), a power management module that provides power to the driver (e.g., the power management module 188 in FIG. 1), a battery (e.g., the battery 189 in FIG. 1), a board (e.g., an MCU board), and a weight part 273 (e.g., a weight).

According to various embodiments disclosed herein, the forward/reverse driver may include at least one wheel 271 and at least one actuator 272. In addition, a gear set connecting the wheel 271 and the actuator 272 may be included. The wheel 271 may serve to rotate the outer housing 210 such that the electronic device 200 is oriented in one direction (e.g., in a direction parallel to the X axis) or in a direction opposite the one direction. According to an embodiment, the wheel 271 may be formed to come into contact with the inner surface 221 of the strip-shaped transparent portion 220. Accordingly, when the wheel 271 rotates through the driving of the actuator 272, the strip-shaped transparent portion 220 rotates by friction with the wheel 271, so that the electronic device is capable of traveling on the ground. However, the wheel 271 is not limited thereto, and although not illustrated in the drawing, the wheel 271 may rotate the outer housing 210 in the state in which the wheel 271 is formed to be in contact with the opaque portions 210a and 210b of the outer housing 210.

According to various embodiments, a second wheel 274 separated from the wheel 271 (hereinafter, referred to as a “first wheel”) may be further included, as illustrated in FIG. 13. The second wheel 274 may be located opposite the first wheel 271 on the basis of the inner housing 240. According to an embodiment, each of the first wheel 271 and the second wheel 274 may come into contact with the inner surface 221 of the strip-shaped transparent portion 220 of the outer housing 210.

Although not illustrated in the drawing, according to an embodiment, like the forward/reverse driver, the direction-converting driver may also include at least one wheel and at least one actuator. In another embodiment, the direction-converting driver may form a power mechanism interlocked with the weight part 273, unlike the forward/reverse driver.

According to various embodiments, an actuator (e.g., the actuator 272) included in the driver may be connected to a controller (e.g., the controller 300 in FIG. 3) to be driven by receiving a control input from the controller. According to an embodiment, an actuator (e.g., the actuator 272) may provide a driving force that moves the first wheel 271, the second wheel 274 or both the first wheel 271 and the second wheel 274 through the controller.

Both the first wheel 271 and the second wheel 274 may at least partially come into contact with the inner surface of the outer housing 210, and may move at the same time. According to various embodiments, the second wheel 274 may be driven dependently on the first wheel 271, or alternatively, may be driven independently of the first wheel 271. Alternatively, the actuator may not be connected to the second wheel 274, and may serve to support the outer housing 210 on the side opposite the first wheel 271.

As described above with reference to the embodiment of FIG. 3, the forward/reverse driver and the direction-converting driver may have various shapes, and the operations thereof may also vary according to embodiments.

According to various embodiments of the disclosure, support members may include a support member 285 for supporting a strip-shaped transparent portion 220 of the outer housing 210 (hereinafter referred to as a “first support member 285”) and a support member 242 for supporting the opaque portions 210a and 210b of the outer housing 210 (hereinafter referred to as a “second support member 242”). Here, the first support member 285 may be disposed above the speaker 281, and the second support member 242 may support the outer housing 210 in a direction substantially opposite the direction in which the first support member 285 supports the outer housing 210.

According to an embodiment, the second support member 242 may have a shape protruding outward on the second hemisphere 240b of the inner housing 240. Multiple second support members 242 may be provided, and as illustrated in FIGS. 7, 11, 13, and 14, multiple second support members 242 (e.g., four second support members 242) may be disposed radially along the surface of the second hemisphere 240b.

The support members (the first support member 285 and the second support member 242) may be configured to maintain the distance between the outer housing 210 and the inner housing 240 constant such that the outer housing 210 is capable of stably traveling on the ground depending on the power transmitted to the outer housing 210 side from the driver. In addition, the support members (the first support member 285 and the second support member 242) may also serve to mitigate a physical shock transmitted to the electronic device 200.

According to various embodiments, by providing the multiple support members, the inner housing 240 and the components included in the inner housing 240 may slide smoothly in the manner that minimizes friction while being located adjacent to the outer housing 210.

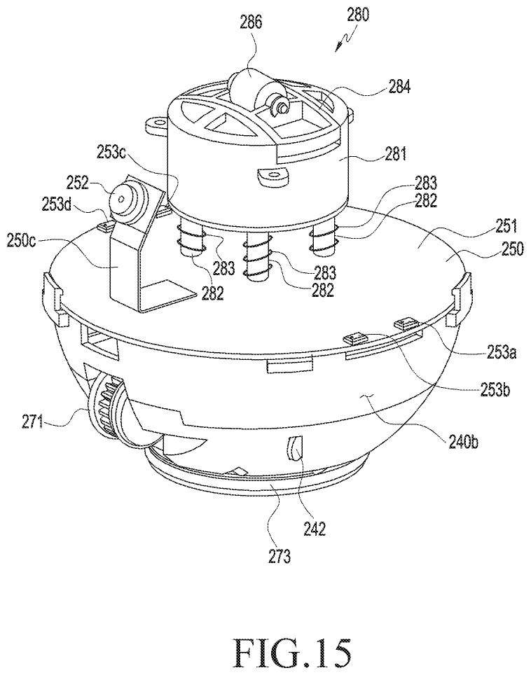

FIG. 15 illustrates a support member according to embodiments different from an embodiment of FIG. 11 according to an embodiment of the disclosure.

Referring to FIG. 15, according to an embodiment, the support member (the first support member) may be in the form of a ball bearing (or a ball caster) (e.g., the first support member 285 of FIG. 11) as illustrated in FIG. 11, or may be in the form of a roller bearing (e.g., the support member 286 in FIG. 15), as illustrated in FIG. 15. In addition, various types of support members, which support the inner surface of the outer housing 210 and are capable of being rolled, may be provided.

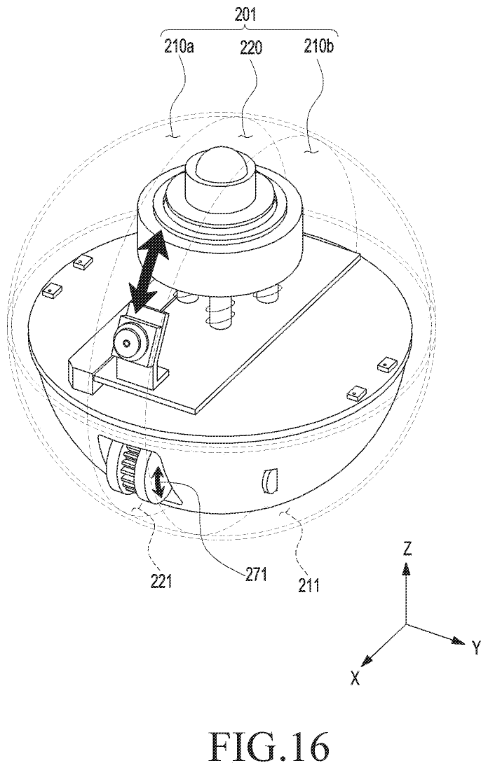

FIG. 16 is a view schematically illustrating the forward/reverse driving of the electronic device according to an embodiment of the disclosure.

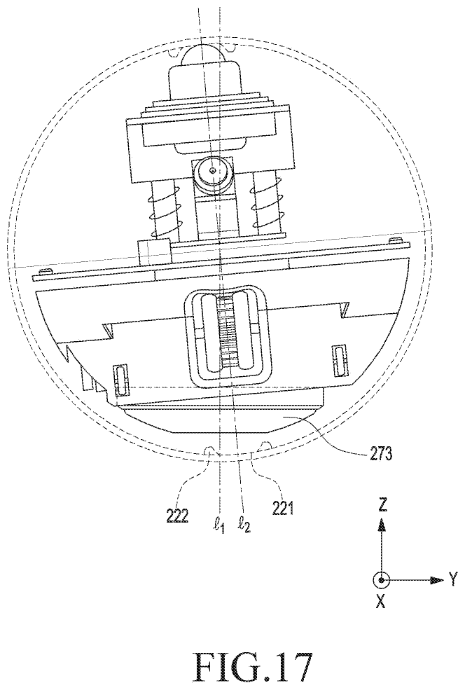

FIG. 17 is a view schematically illustrating the direction-converting driving of the electronic device according to an embodiment of the disclosure.

The forward/reverse driving of the electronic device 200 may be performed in response to an action of pushing the ground in the direction opposite the direction in which the outer housing 210 travels in the state in which at least a portion of the outer housing 210 is in contact with the ground.

Referring to FIG. 16, according to various embodiments, the electronic device 200 may roll in the first direction in the state in which the electronic device 200 is placed on the ground. For example, assuming that the virtual plane formed by the directional components X and Y is the ground on which the electronic device 200 (e.g., the electronic device 101) moves, the electronic device 200 may move forward or backward in the first direction (e.g., the direction parallel to the X axis) (or the direction in which the Y axis serves as a rotation axis) in the virtual plane formed by the directional components X and Y.

According to various embodiments, at least a portion of the outer housing 210 (e.g., the strip-shaped transparent portion 220) may be rotated in the rolling operation of the electronic device 200. According to an embodiment, only the strip-shaped transparent portion 220 may be rotated during the rolling operation of the electronic device 200. According to another embodiment, the strip-shaped transparent portion 220 and the opaque portions 210a and 210b may be rotated together during the rolling operation of the electronic device 200.

According to various embodiments, the electronic device 200 may yaw on the basis of the rotation axis perpendicular to the first direction. The electronic device 200 may rotate with reference to the rotation axis in a direction perpendicular to the first direction (e.g., a direction parallel to the Z axis).

According to various embodiments, the electronic device 200 may be tilted toward the second direction in the state of being placed on the ground. Here, the second direction may be a direction perpendicular to the first direction (the direction parallel to the Y axis) on the virtual plane formed by the directional components X and Y. The wording “tilted toward the second direction” may mean that the inclination varies on the virtual plane formed by the directional components Y and Z.

Referring to FIG. 17, an example, in which the electronic device 200 is tilted toward the second direction, is illustrated. For reference, FIG. 13 may illustrate the state in which the electronic device 200 is not tilted. As illustrated in FIG. 13, the non-tilted electronic device 200 has a virtual line 11 passing through the centers of the support member 285, the speaker 281, the camera 252, and the substrate 250. As illustrated in FIG. 17, the tilted electronic device 200 may have a virtual line 12 passing through the centers of the support member 285, the speaker 281, the camera 252, and the substrate 250. The virtual line L2 may be tilted as a whole with respect to the virtual line L1.

The operation illustrated in FIG. 17 may be performed by the driving of the direction-converting driver 275. According to an embodiment, the direction-converting driver 275 may be interlocked with the weight part 273 to tilt the remaining components of the electronic device 200 except for the weight part 273 and the direction-converting driver 275.

When the forward/reverse driving is performed as in the embodiment illustrated in FIG. 16 in the state in which the electronic device 200 is inclined as in the embodiment illustrated in FIG. 17, the electronic device 200 may change direction while traveling.

The operations illustrated in FIGS. 16 and 17 or operations, not described with reference to the drawings but provided according to various embodiments disclosed herein, may be performed in combination with each other, or may be performed as individual operations.

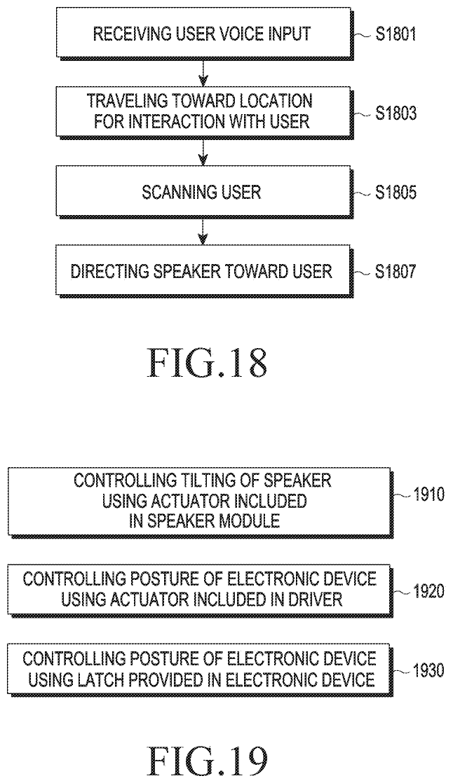

FIG. 18 is a view illustrating an operation algorithm of the electronic device 200 (e.g., the electronic device in FIG. 11) according to an embodiment of the disclosure.

Referring to FIG. 18, according to an embodiment, the operation of the electronic device (e.g., the electronic device 200 in FIG. 11) be started by first receiving a user's voice input through a microphone (operation S1801), and analyzing the location of the user using the user's voice input. The location of the user may be accurately estimated using multiple microphones provided in the electronic device.

If necessary, the electronic device (e.g., the electronic device 200 in FIG. 11) may travel toward an optimal position for interaction with the user analyzed through the controller (e.g., the controller 300 in FIG. 3) (or the processor) (operation S1803). Such a case may be the case in which the distance between the electronic device and the user is reduced, for example, when the user's voice has a value smaller than a predetermined value in the interaction with the user or when a noise having a value equal to or larger than an allowed value is detected. According to another embodiment, such a case may be the case in which the electronic device needs to travel toward a user other than the user who issued the command. In addition, various other embodiments are applicable.

The electronic device (e.g., the electronic device 200 of FIG. 11) may perform an operation of scanning an object (e.g., a user) separately (or independently) from the traveling operation of the electronic device (operation S1805). For example, multiple of users may exist around the electronic device. The electronic device may scan the users in order to distinguish a user who issues a command to the electronic device or a user for whom the operation of the electronic device is to be performed.

The electronic device (e.g., the electronic device 200 in FIG. 11) may perform operation S1807 of directing the speaker toward the user. More precise interaction with the user may be performed through the operation of directing the speaker (S1807), and when the electronic device does not travel as far as the distance to travel, the operation may serve to compensate for the same.

FIG. 19 is a view illustrating a method of directing a speaker (e.g., the speaker 281 in FIG. 11) toward a user according to an embodiment of the disclosure.

FIG. 20 is a view illustrating a method of directing a speaker towards a user according to an embodiment of the disclosure.

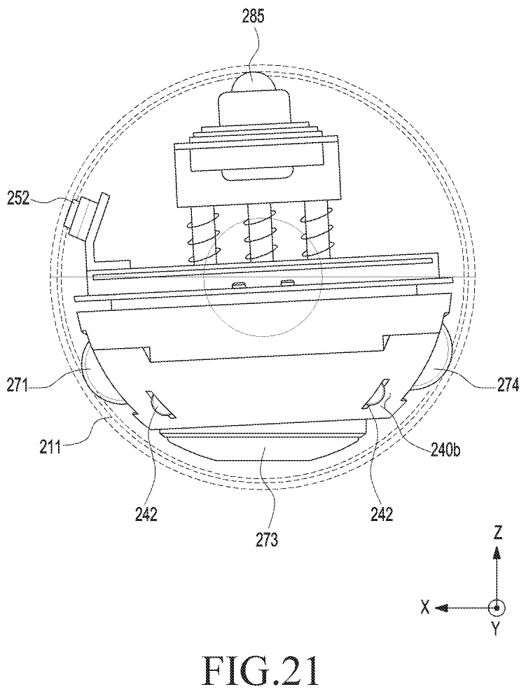

FIG. 21 is a view illustrating a method of directing a speaker towards a user according to an embodiment of the disclosure.

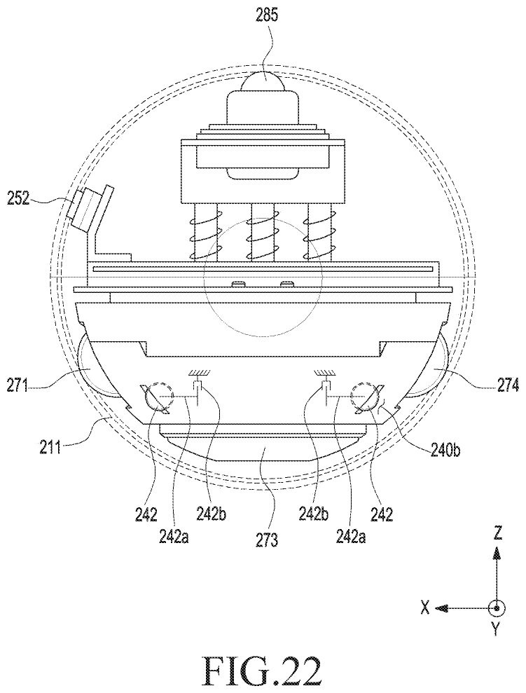

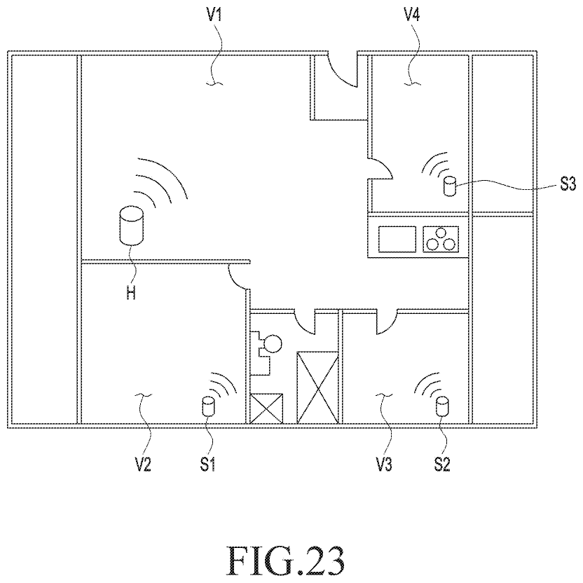

FIG. 22 is a view illustrating a method of directing a speaker towards a user according to an embodiment of the disclosure.

The method of directing a speaker toward a user may be variously set. According to an embodiment, the tilt of the speaker may be controlled using an actuator included in the speaker 281 module (1910).

Referring to FIGS. 19 and 20, unlike the actuator provided for driving or changing the direction of an electronic device, a separate actuator 281d may be included in the speaker module 280, and the speaker 281 may be tilted by a predetermined angle depending on the driving of the actuator 281d. According to an embodiment, the actuator 281d illustrated in FIG. 20 may be made of a combination of a gearbox and a servomotor inside the speaker module 280. The gearbox and the servomotor may be formed inside the speaker housing 281c of the speaker module 280.

According to various embodiments, in the state in which the electronic device (e.g., the electronic device 200 of FIG. 11) is spaced apart from a user by a predetermined distance (or a designated distance), a sound-emitting angle may be adjusted depending on data related to transceiver performance measured in real time if necessary. For example, as illustrated in FIG. 20, the transceiver performance may be remarkably improved depending on the degree of tilting of the speaker 281 compared with the case in which the speaker 281 is not tilted.

According to another embodiment, the posture of the electronic device (e.g., the electronic device 200 in FIG. 11) may be controlled using an actuator included in the driver (1920).

Referring to FIG. 19 and FIG. 21 together, the posture of the electronic device may be controlled using an actuator provided for traveling or changing the direction of the electronic device. For example, when driving an actuator (e.g., the actuator 272 in FIG. 13) provided for traveling of the electronic device, the wheel 271 is engaged with the inner surface 221 (or the inner surface 211) of the outer housing 210 to move the outer housing 210 forward or backward. When the applied driving force of the actuator (e.g., the actuator 272 in FIG. 13) is less than the static frictional force between the wheel 271 and the inner surface 211 of the outer housing 210, the components inside the outer housing 210, except for only some components including the outer housing 210 and the weight part 273, may be tilted. In this case, since the actuator included in the driver is not operated for traveling or changing direction, the posture of the electronic device may be finely controlled using less power than that required for traveling or changing the direction.

According to another embodiment, the posture of the electronic device may be controlled using a latch installed in the electronic device (e.g., the electronic device 200 in FIG. 11) (1930).

Referring to FIG. 19 and FIG. 22 together, the latch installed in the electronic device may be a structure that is provided separately from the structure for traveling or changing the direction of the electronic device, and may change the inclination of the entire electronic device.

The latch may be, for example, a brake 242b that engages with the rotary shaft 242a of the support member 242. According to an embodiment (e.g., when the tilting of the speaker is not necessary), the rotary shaft 242a, extending to one side of the support member 242, may be installed to be freely rotatable without being restrained by a structure (e.g., the brake 242b) inside the electronic device.

According to an embodiment (e.g., when the tilting of the speaker is necessary), the rotary shaft 242a, extending to one side of the support member 242, may be restrained by a structure (e.g., the brake 242b) inside the electronic device. As the support member 242 is not freely rotatable, the free rotation of the outer housing 210 may also be restrained. At this time, when the actuator included in the forward/reverse driver is additionally driven, the speaker included in the electronic device (e.g., the electronic device 200 in FIG. 11) may be slightly tilted.

In the embodiment illustrated in FIG. 22, the electronic device or components included therein are not tilted. According to another embodiment, unlike what is illustrated in the drawing, the electronic device or at least some of the components included therein may be tilted.

Referring to FIGS. 19, 20, 21, and 22, the methods for directing a speaker toward a user, described above may be independently or selectively performed, and the components for executing the methods may be independently or selectively employed in the electronic device (e.g., the electronic device 200 of FIG. 11).

In the embodiments described above, the angle of tilt for directing the speaker toward a user may be variously set depending on the situation in consideration of all of the distance between the user and the electronic device (e.g., the electronic device 200 in FIG. 11), the movable range, and the magnitude of the received user's voice.

According to an embodiment, while the electronic device 200 moves in a direction parallel to the directional component of the X axis, the speaker 281 may move while maintaining the state perpendicular to the virtual plane formed by the directional components X and Y. After the electronic device 200 moves to a location for interaction with the user, the speaker 281 may be tilted toward the user so as to maintain a smooth interaction situation.

According to various embodiments disclosed herein, when the first input information is received, the electronic device (e.g., the electronic device 200) may include a controller (e.g., the controller 300 in FIG. 3) (e.g., the processor 120) configured, when receiving first input information, to control the forward/reverse driver (e.g., the forward/reverse driver 321 in FIG. 3) and the direction-converting driver (e.g., the direction-converting driver 322 in FIG. 3) in response to the first input information such that the electronic device moves in a first direction and configured, when receiving second input information, to control the speaker (e.g., the speaker 281 in FIG. 11) in response to the second input information such that the speaker (e.g., the speaker 281 in FIG. 11) is oriented in the first direction or a second direction different from the first direction.

According to various embodiments, the first input information and the second input information may be “commands or data” input to the electronic device at the same time or at different times. According to an embodiment, the first input information and the second input information may be the same “command or data” or different “command or data”.

When the first input information and the second input information are input, the processor (e.g., the processor 120) may execute software (e.g., the program 140) to control at least one driver (e.g., the forward/reverse driver or the direction-converting driver) related to the traveling of the electronic device (e.g., the processor 120) connected to the processor (e.g., the processor 120), or to control at least one other driving element (actuator or latch included in the speaker module) that is not related to the traveling of the electronic device.

According to various embodiments, the operation of controlling the forward/reverse driver and the operation of controlling the direction-converting driver may be independently performed by the controller (e.g., the controller 300 in FIG. 3) (e.g., the processor 120). In addition, the operation of controlling the forward/reverse driver and the direction-converting driver by the controller (e.g., the controller 300 in FIG. 3) (e.g., the processor 120) and the operation of controlling the actuator or the latch included in the speaker module by the controller (e.g., the controller 300 in FIG. 3) (e.g., the processor 120) may be performed independently. Therefore, when the electronic device 200 moves, the speaker module may move therewith, and when the electronic device 200 does not move, only the speaker module 280 may move.

According to various embodiments, the processor (e.g., the processor 120) may be remote-controlled by an external electronic device (e.g., the electronic device 102, the electronic device 104, or the server 108) using a communication module (e.g., the communication module 190) included in the electronic device (e.g., the electronic device 200). Accordingly, the mobile electronic device (e.g., the electronic device 102, the electronic device 104, or the server 108) may be directly operated by an external object or a third object.

According to various embodiments, the processor (e.g., the processor 120) may control at least one driver (e.g., the forward/reverse driver or the direction-converting driver) related to the traveling of the electronic device (e.g., the electronic device 200) or may control at least one other driving element (actuator or latch included in the speaker module) that is not related to the traveling of the electronic device, using a rule-based model or an artificial intelligence model.

According to various embodiments, the rule-based model may be configured to: a) determine the validity of an event, b) contact a knowledge base (not illustrated) provided in an electronic device (e.g., the electronic device 200) for information and receive a response therefrom when an event occurs, c) create an action corresponding to the event, d) determine priorities of actions, or e) perform the action having the highest priority. For example, when an event for receiving input information occurs, if the event includes two pieces of information about a sound output and a position movement in the input information, the processor (e.g., the processor 120) may determine which action should be prioritized during the sound output and the position movement according to a rule-based model, and may perform an action on the basis of the determination (e.g., outputting predetermined sound after the position movement). For example, the movement path of the electronic device (e.g., the electronic device 200) may be set through the rule-based model using the location of the external object or the distance between the electronic device (e.g., the electronic device 200) and the external object as an input value.

According to various embodiments, an artificial intelligence model may be learned according to at least one of machine learning, neural network, and deep learning algorithms. For example, the movement path of the electronic device (e.g., the electronic device 200) may be set through the artificial intelligence model using the location of the external object or the distance between the electronic device (e.g., the electronic device 200) and the external object as an input value. According to an embodiment of the disclosure, an optimal movement path may be set by identifying the position of an obstacle using the artificial intelligence model.

An electronic device (e.g., the electronic device 101 in FIG. 1 or the electronic device 200 in FIG. 2) according to various embodiments disclosed herein may be any of various types of devices. The electronic devices may include, for example, a portable communication device (e.g., a smart phone), a computer device, a portable multimedia device, a portable medical device, a camera, a wearable device, or a home appliance. According to an embodiment, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. Herein, each of phrases, such as “A or B”, “at least one of A and B”, “at least one of A or B”, “A, B, or C”, “at least one of A, B, and C”, “at least one of A, B, or C” may include any one of the items listed together in the corresponding phrase or all possible combinations of the items. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” or “connected with,”, it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it. This allows the machine to be operated to perform at least one function according to the invoked at least one instruction. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities. According to various embodiments, one or more components of the above-described components or operations may be omitted, or one or more other components or operations may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

According to various embodiments disclosed herein, it is possible to provide an electronic device (e.g., the electronic device 200 in FIG. 11) including: a speaker (e.g., the speaker 281 in FIG. 11); a microphone (e.g., the microphone 253a, 253b, 253c, or 253d in FIG. 11); a substrate (e.g., the substrate 250 in FIG. 11) on which the speaker and the microphone are mounted; a spherical housing (e.g., the outer housing 210 in FIG. 11) defining therein an inner space in which the speaker, the microphone, and the substrate are disposed; a support member (e.g., the support member 285 in FIG. 11) configured to be in contact with and support an inner surface of the housing on one side thereof; and a driver disposed in the inner space of the housing and including at least one power generation actuator (e.g., the actuator 272 in FIG. 13) and at least one wheel (e.g., the wheel 271 in FIG. 13) configured to rotate the housing by receiving power from the actuator, wherein the speaker is disposed adjacent to an another side of the support member opposite the one side of the support member, which is in contact with the inner surface of the housing, and configured to outputs sound using oscillation of the surface of the housing.

According to various embodiments, the speaker may be a vibration speaker, which is disposed adjacent to an upper end of the housing in the inner space of the housing, the vibration speaker being configured to transmit the oscillation to the inner surface of the housing via the support member.

According to various embodiments, the speaker may be configured to be tiltable so as to be directed toward an external object disposed outside the electronic device.

According to various embodiments, the electronic device may further include an elastic body (e.g., the elastic body 283) disposed between the speaker and the substrate.

According to various embodiments, the electronic device may further include an object detector (e.g., the camera 252 in FIG. 11) and at least one of a sensor unit configured to acquire information on the external object and a camera configured to capture an image of an outside of the electronic device.

According to various embodiments, at least a portion of the housing may include a transparent portion, and the transparent portion may be formed to correspond to the position at which the object detector is disposed.

According to various embodiments, the housing may include two substantially opaque portions (e.g., the opaque portions 210a and 210b in FIG. 11) and the transparent portion (e.g., the strip-shaped transparent portion 220 in FIG. 11) having a strip shape and formed between the two substantially opaque portions, and the transparent portion may be formed to correspond to a portion in which the object detector is disposed.

According to various embodiments, the housing may include an outer housing configured to come into contact with a ground and an inner housing disposed inside the outer housing and spaced apart from the inner surface of the outer housing by a predetermined distance.

According to various embodiments, the housing may have openings (e.g., the microphone hole case 230 in FIG. 2) for voice reception, which are formed at opposite sides thereof, respectively, and the microphone may be disposed on the substrate at a position corresponding to a position of each of the openings.

According to various embodiments, the openings at the opposite sides may be formed to be parallel to a forward/reverse rotary shaft of the driver.

According to various embodiments, at least one microphone may be provided on the substrate at each of positions corresponding the openings at the opposite sides of the housing, and a total of three or more microphones may be provided on the substrate.

According to various embodiments, the driver may include a forward/reverse driver configured to rotate the housing about a rotary shaft parallel to a ground on which the electronic device travels.

According to various embodiments, the driver may further include a direction-converting driver configured to rotate the housing about a rotary shaft perpendicular to the ground, or configured to tilt the housing leftward and rightward.

According to various embodiments, the support member may include a first support member (e.g., the first support member 285 in FIG. 11) configured to support the inner surface of the housing at one side thereof and connected to the speaker at an another side thereof, and a second support member (e.g., the second support member 242 in FIG. 11) configured to support the housing in a direction substantially opposite a direction in which the first support member supports the housing.

According to various embodiments, the electronic device may further include a controller (e.g., the controller 300 in FIG. 3) configured to: control, when receiving first input information, the driver to move the housing to a position, which is newly designated in response to the received first input information; and configured to control, when receiving second input information, the speaker to be oriented in a first direction or a second direction different from the first direction in response to the received second input information.

According to various embodiments disclosed herein, it is possible to provide an electronic device including: a speaker (e.g., the speaker 281 in FIG. 11); an object detector (e.g., the camera 252 in FIG. 11); a microphone (e.g., the microphone 253a, 253b, 253c, or 253d in FIG. 11); a substrate (e.g., the substrate 250 in FIG. 11) on which the speaker, the object detector, and the microphone are mounted; a housing including a spherical outer housing (e.g., the outer housing 210 in FIG. 8A) defining therein an inner space in which the speaker, the object detector, the microphone, and the substrate are disposed, the outer housing being configured to come into contact with a ground, and an inner housing (e.g., the inner housing 240 in FIG. 8B) disposed inside the outer housing and spaced apart from the inner surface of the outer housing by a predetermined distance; a first support member (e.g., the first support member 285 in FIG. 11) configured to come into contact and support the inner surface of the housing at one side thereof and connected to the speaker at an another side thereof; multiple second support members (e.g., the second support members 242 in FIG. 8B) configured to maintain the distance between the inner housing and the outer housing constant; a forward/reverse driver including at least one power generation actuator (e.g., the actuator 272 in FIG. 13) and at least one wheel (e.g., the wheel 271 in FIG. 13) configured to drive the outer housing by receiving power from the actuator; and a direction-converting driver configured to rotate the housing about a rotary shaft perpendicular to the ground, or configured to tilt the housing leftward and rightward, wherein the speaker outputs sound by causing the surface of the outer housing to oscillate.

According to various embodiments, the speaker may be a speaker tiltable so as to be directed toward an external object disposed outside the electronic device.

According to various embodiments, the electronic device may further include an elastic body (e.g., the elastic body 283 in FIG. 11) disposed between the speaker and the substrate.

According to various embodiments, the outer housing includes two substantially opaque portions (e.g., the opaque portions 210a and 210b in FIG. 11) and the transparent portion (the strip-shaped transparent portion 220 in FIG. 11) having a strip shape and formed between the two substantially opaque portions, the transparent portion being formed to correspond to a portion in which the object detector is disposed.

According to various embodiments, at least one microphone may be provided on the substrate at each of positions corresponding to the openings at the opposite sides of the housing, and a total of three or more microphones may be provided on the substrate.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device comprising:
a speaker;
a microphone;
a substrate on which the speaker and the microphone are mounted;
a spherical housing defining therein an inner space in which the speaker, the microphone, and the substrate are disposed;
a support member configured to be in contact with and support an inner surface of the spherical housing on one side thereof; and
a driver disposed in the inner space of the spherical housing and including at least one power generation actuator and at least one wheel configured to rotate the spherical housing by receiving power from the least one power generation actuator,
wherein the speaker is disposed adjacent to another side of the support member opposite the one side of the support member, which is in contact with the inner surface of the spherical housing, and configured to output sound using oscillation of the inner surface of the spherical housing.

2. The electronic device of claim 1, wherein the speaker is a vibration speaker, which is disposed adjacent to an upper end of the spherical housing in the inner space of the spherical housing, the vibration speaker being configured to transmit the oscillation to the inner surface of the spherical housing via the support member.

3. The electronic device of claim 1, wherein the speaker is configured to be tiltable so as to be directed toward an external object disposed outside the electronic device.

4. The electronic device of claim 1, further comprising:
an elastic body disposed between the speaker and the substrate.

5. The electronic device of claim 1, further comprising:
an object detector; and
at least one of a sensor configured to acquire information on an external object or a camera configured to capture an image of an outside of the electronic device.

6. The electronic device of claim 5, wherein at least a portion of the spherical housing comprises a transparent portion, and the transparent portion is formed to correspond to a position at which the object detector is disposed.

7. The electronic device of claim 6, wherein the spherical housing comprises two substantially opaque portions and the transparent portion having a strip shape and formed between the two substantially opaque portions, the transparent portion being formed to correspond to a portion in which the object detector is disposed.

8. The electronic device of claim 1, wherein the spherical housing comprises:
an outer housing configured to come into contact with a ground, and
an inner housing positioned inside the outer housing and spaced apart from the outer housing by a predetermined distance.

9. The electronic device of claim 1,
wherein the spherical housing has openings for voice reception, which are formed at opposite sides thereof, respectively, and
wherein the microphone is disposed on the substrate at a position corresponding to a position of each of the openings.

10. The electronic device of claim 9, wherein the openings at the opposite sides are formed to be parallel to a forward/reverse rotary shaft of the driver.

11. The electronic device of claim 10, wherein at least one microphone is provided on the substrate at each of positions corresponding to the openings at the opposite sides of the spherical housing, and a total of three or more microphones are provided on the substrate.

12. The electronic device of claim 1, wherein the driver comprises a forward/reverse driver configured to rotate the spherical housing about a rotary shaft parallel to a ground on which the electronic device travels.

13. The electronic device of claim 12, wherein the driver further comprises a direction-converting driver configured to rotate the spherical housing about a rotary shaft perpendicular to the ground, or configured to tilt the spherical housing leftward or rightward.

14. The electronic device of claim 1,
wherein the support member comprises:
a first support member configured to support the inner surface of the spherical housing at one side thereof and connected to the speaker at another side thereof, and
a second support member configured to support the spherical housing in a direction substantially opposite a direction in which the first support member supports the spherical housing.

15. The electronic device of claim 1, further comprising:
a processor configured to control, when receiving first input information, the driver to move the spherical housing to a position, which is newly designated in response to the received first input information; and configured to control, when receiving second input information, the speaker to be oriented in a first direction or a second direction different from the first direction in response to the received second input information.

16. An electronic device comprising:
a speaker;
an object detector;
a microphone;
a substrate on which the speaker, the object detector, and the microphone are mounted;
a housing including a spherical outer housing defining therein an inner space in which the speaker, the object detector, the microphone, and the substrate are disposed, the spherical outer housing being configured to come into contact with a ground, and an inner housing disposed inside the spherical outer housing and spaced apart from the spherical outer housing by a predetermined distance;
a first support member configured to come into contact with and support an inner surface of the housing at one side thereof and connected to the speaker at another side thereof;
multiple second members configured to maintain the distance between the inner housing and the spherical outer housing constant;
a forward/reverse driver including at least one power generation actuator and at least one wheel configured to drive the spherical outer housing by receiving power from the at least one power generation actuator; and
a direction-converting driver configured to rotate the housing about a rotary shaft perpendicular to the ground, or configured to tilt the housing leftward and rightward,
wherein the speaker outputs sound by causing the surface of the spherical outer housing to oscillate.

17. The electronic device of claim 16, wherein the speaker is configured to be tilted so as to be directed toward an external object disposed outside the electronic device.

18. The electronic device of claim 16, further comprising:
an elastic body disposed between the speaker and the substrate.

19. The electronic device of claim 16, wherein the housing comprises two substantially opaque portions and a transparent portion having a strip shape and formed between the two substantially opaque portions, the transparent portion being formed to correspond to a portion in which the object detector is disposed.

20. The electronic device of claim 16, wherein at least one microphone is provided on the substrate at each of positions corresponding to openings at the opposite sides of the housing, and a total of three or more microphones are provided on the substrate.
